(19) United States
(12) Patent Application Publication
(10) Pub. No.: US 2021/0302342 A1
(43) Pub. Date: Sep. 30, 2021

(54) SAMPLE CONTAINER FOR THERMAL ANALYSIS AND THERMAL ANALYZER

(71) Applicant: HITACHI HIGH-TECH SCIENCE CORPORATION, Tokyo (JP)

(72) Inventors: Ryokuhei YAMAZAKI, Tokyo (JP); Shinya NISHIMURA, Tokyo (JP)

(21) Appl. No.: 17/175,140

(22) Filed: Feb. 12, 2021

(30) Foreign Application Priority Data
Mar. 26, 2020 (JP) 2020-071320

(51) Int. Cl. G01N 25/20; G01K 17/00; G01N 5/04

(52) U.S. Cl. CPC G01N 25/20; G01N 5/04; G01K 17/00

(57) ABSTRACT

Disclosed is a thermal analyzer allowing observation of a sample. The thermal analyzer allows reliable observation of a film-like sample by solving a problem in that the film-like sample undergoes thermal deformation such as shrinkage or warping when the sample is heated or cooled. Further disclosed is a sample container for a thermal analyzer that is used to measure thermal behaviors of a sample attributable to heating or cooling of the sample and to observe the sample. The container includes a main body having a cylinder-shaped bottom and an open cylinder-shaped top and a transparent or translucent pressure plate that is in contact with an inner surface of the opening of the main body and presses down at least the pressure plate placed on a sample placed on the bottom surface of the main body.

### CROSS REFERENCE TO RELATED APPLICATION

The present application claims priority to Korean Patent Application No. 2020-071320, filed Mar. 26, 2020, the entire contents of which is incorporated herein for all purposes by this reference.

### BACKGROUND OF THE INVENTION

### Field of the Invention

The present invention relates to a sample container for physical thermal analysis of a sample while heating or cooling the sample and to a thermal analyzer using the same.

### Description of the Related Art

Conventionally, as a method of evaluating the temperature characteristics of a sample, a thermal analysis technique that measures changes in physical properties of a sample attributable to temperature changes while heating or cooling the sample is used. Thermal analysis is defined in HS K0129:2005 “General Rules for Thermal Analysis”, and a method of measuring the physical properties of a sample while program-controlling the temperature a measurement target (sample) is called thermal analysis. There are five thermal analysis techniques: (1) differential thermal analysis (DTA) to detect temperature (temperature difference), (2) differential scanning calorimetry (DSC) to detect heat flow difference, (3) thermogravimetry (TG) to detect weight (weight change), (4) thermomechanical analysis (TMA) to detect mechanical properties, and (5) dynamic mechanical analysis (DMA).

Further, in recent years, there has been a demand for observing the state of a sample during thermal analysis, and a thermal analyzer is known in which a heating furnace for heating a sample is provided with an opening and the sample is observed through the opening. (See, for example, Patent Literatures 1 and 2).

Further, for such an observation, a sample container having a cylinder-shaped bottom and an open cylinder-shaped top, which is described in Patent Literature 2, is used. In addition, a closed sample container in which a front cap covers the front end of a container and presses a sample in the container to stabilize the contact between the sample and the bottom surface of the container is known (See, for example, Patent Literature 3).

### DESCRIPTION OF RELATED ART

### Patent Literature

(Patent Literature 1) Japanese Patent Application Publication No. H8-327573

(Patent Literature 2) Japanese Patent Application Publication No. 2017-173209

(Patent Literature 3) Japanese Patent Application Publication No. S62-231147

### SUMMARY OF THE INVENTION

Film-like samples such as polymer films and paper are likely to experience thermal deformation such as shrinkage and warpage when the samples are heated. In this regard, conventional sample containers have problems in that a conventional open-end container cannot reduce the thermal deformation of a sample contained therein and that a sample contained in a conventional closed-end container cannot be observed.

On the other hand, a conventional thermal analyzer for observing a sample container has problems in that, when thermal deformation of a sample occurs during heating or cooling, reflection, and angle of light change in accordance with a change in inclination of the surface of the sample, observation of the sample for color and structure is interfered, and a region of the sample to be analyzed is changed because a position of the sample to be observed is changed.

Therefore, the present invention has been made to solve the problems occurring in the conventional arts, and an objective of the present invention is to provide a sample pressure jig with which a sample can be stably observed even when the sample is heated or cooled, and a thermal analyzer using the same.

In order to achieve the above objective, the present invention includes a sample container configured to accommodate a sample to be measured and a pressure plate configured to press the sample such that the sample remains in contact with a bottom of the sample container and provided with at least a portion that is transparent or translucent. With the transparent pressure plate, the sample can be observed from above, and thermal deformation of the sample can be suppressed.

The pressure plate may be made of any one selected from among quartz glass, sapphire glass, YAG ceramics, Tempax glass, NeoCeram glass, Vycor glass, and Pyrex glass.

With the use of the pressure plate, changes in the sample can be observed from above through the pressure plate while the sample is heated or cooled. In addition, since the pressure plate presses and holds the sample from above, the thermal deformation of the sample can be reduced.

By reducing the thermal deformation of the sample, it is possible to prevent changes in the inclination of the sample surface. This prevents reflection of light on the sample surface during the heating or cooling of the sample, thereby allowing changes in the color and structure of the sample to be accurately observed.

In addition, when changes in properties of a region of the sample in accordance with a change in temperature of the sample are observed through image analysis, in a case where the sample undergoes thermal deformation, since the region to be observed is affected by the thermal deformation, an error occurs in the analysis result. The present invention can reduce the thermal deformation of the sample, thereby reducing an error in analysis result and improving the accuracy of the analysis.

By reducing the thermal deformation of the sample, it is possible to stabilize the contact between the bottom surface of the container and the sample according to the thermal deformation. This stabilizes the measurement of caloric value and weight by detecting a signal via a sensor in contact with the bottom surface of the container, thereby improving the accuracy of measurement. The pressure plate holds the sample down on the bottom surface of the container by pressing the sample from above with a portion thereof or the weight thereof.

According to the present invention, when a sample is heated or cooled, it is possible to reduce thermal deformation of the sample, thereby allowing reliable observation of the sample. Further, since the thermal deformation of the sample is reduced when the sample is heated or cooled, the properties of the sample can be accurately evaluated through thermal analysis.

### BRIEF DESCRIPTION OF THE DRAWINGS

FIG. 1 is a cross-sectional view illustrating the construction of a thermal analyzer according to one embodiment of the present invention;

FIG. 2 is a cross-sectional view taken along an axial direction L, which illustrates the construction of a measurement sample container according to a first embodiment of the present invention;

FIG. 3 is a top view illustrating the construction of the measurement sample container according to the first embodiment of the present invention;

FIG. 4 is a cross-sectional view illustrating the construction of a measurement sample container according to a second embodiment of the present invention;

FIG. 5 is a top view illustrating the construction of the measurement sample container according to the second embodiment of the present invention;

FIG. 6 is a top view illustrating the construction of a measurement sample container according to one modification to the second embodiment of the present invention;

FIG. 7 is a cross-sectional view taken along an axial direction L, which illustrates the construction of a measurement sample container according to a third embodiment of the present invention;

FIG. 8 is a top view illustrating the construction of the measurement sample container according to the third embodiment of the present invention;

FIG. 9 is a cross-sectional view taken along an axial direction L, which illustrates the construction of a measurement sample container according to a fourth embodiment of the present invention;

FIG. 10 is a top view illustrating the construction of the measurement sample container according to the fourth embodiment of the present invention;

FIG. 11 is a cross-sectional view taken along an axial direction L, which illustrates the construction of a measurement sample container according to a fifth embodiment of the present invention;

FIG. 12 is a top view illustrating the construction of the measurement sample container according to the fifth embodiment of the present invention; and

FIG. 13 is a flowchart illustrating operation of a thermal analyzer using a sample container according to the present invention.

### BRIEF DESCRIPTION OF THE DRAWINGS

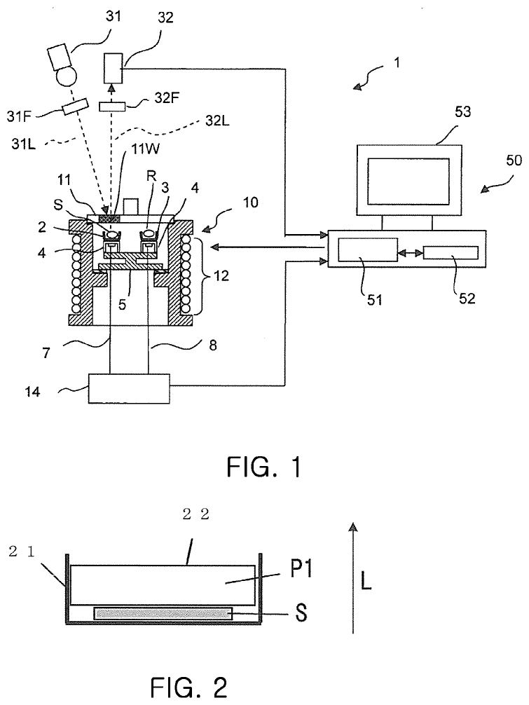

Hereinafter, embodiments of the present invention will be described with reference to the accompanying drawings. FIG. 1 is a cross-sectional view illustrating the construction of a thermal analyzer according to one embodiment of the present invention.

A thermal analyzer 1 is a differential scanning calorimeter (DSC), and has the same configuration as a conventional differential scanning calorimeter except that a lid 11 of a heating furnace 10 is provided with a window 11W allowing observation of the internal space of the heating furnace. Therefore, the outline of the thermal analyzer 1 will be described.

The thermal analyzer 1 includes a measurement sample container 2 for accommodating a measurement sample S, a reference material container 3 for accommodating a reference material R, a heating furnace 10, a thermal resistor 4 connected between the heating furnace 10 and each of the measurement sample container 2 and the reference material container 3 to form a heat flow path, a measurement sample-side thermocouple 7, a reference material-side thermocouple 7, a light source 31 such as an LED serving as an illumination means for irradiating at least the measurement sample S with visible light, a CCD camera 41 serving as an imaging means for capturing an image of at least the measurement sample S, and a personal computer 50.

A coil heater 12 is wound around the outer surface of the heating furnace 10 to heat the heating furnace 10. The outside of the heater 12 is covered with a cover (not illustrated).

The CCD camera 41 is, for example, an area scan camera. Alternatively, the CCD camera 41 may be a line scan camera. Further alternatively, the CCD camera may be replaced with a CMOS camera using a different solid-state imaging element.

The personal computer 50 includes a central processing unit (CPU) 51, a storage unit 52 such as a hard disk, a display unit 53 such as a liquid crystal monitor, and a keyboard and mouse (not illustrated).

The heating furnace 10 is formed in a cylindrical shape and has an H-shaped cross section when it is taken along an axial direction. Then, a heat plate 5 having a substantially double disk shape is disposed above an annular protrusion protruding radially inward from the center in the axial direction.

The measurement sample container 2 and the reference substance container 3 are placed on the upper surface of the heat plate 5 via two thermal resistors 4, respectively, and the measurement sample container 2 and the reference substance container 3 are accommodated in an internal space surrounded by the heating furnace 10.

The measurement sample container 2 contains the measurement sample S, and a transparent or translucent pressure plate is placed on the upper surface of the measurement sample S. The pressure plate is made of a transparent material that has a predetermined transmittance and can transmit visible light. Alternatively, the pressure plate is made of a translucent material. As the transparent material, quartz glass, sapphire glass, or yttrium aluminum garnet (YAG) ceramics, Tempax, Neocerum, Vycor, and Pyrex may be preferably used.

On the other hand, it is preferable that a pressure plate is placed on the reference material R contained in the reference material container 3 in the same manner as that a pressure plate is placed on the measurement sample S contained in the measurement sample container in order for the reference material R and the measurement sample S are heated under the same conditions in the heating furnace. However, the pressure plate placed on the reference material S may be optional.

The measurement sample-side thermocouple 7 and the reference material-side thermocouple 7 pass through the heat resistor 4 and the heat plate 5, and their tips are connected to the lower surfaces of the measurement sample container 2 and the reference material container 3, respectively through brazing or the like. On the other hand, the other ends of the measurement sample-side thermocouple 7 and the reference material-side thermocouple 7 that extend from the lower end of the heating furnace 10 and are connected to an amplifier 14 constituting a signal processing circuit.

In this way, the measurement sample-side thermocouple 7 and the reference material-side thermocouple 7 form a so-called differential thermocouple which can detect a temperature difference between the measurement sample S and the reference material R. This temperature difference is recorded as a heat flow difference signal. In addition, the temperature of the measurement sample is detected by the measurement sample-side thermocouple 7 and is recorded.

Further, the temperature of the heating furnace 10 is input to the CPU 51 via various control circuits, and the CPU 51 controls the heating furnace 10 to be heated or cooled at a constant speed by controlling current supply to the heater 12.

The lid 11 is detachably attached to the heating furnace to cover the upper end opening of the heating furnace 10, thereby shielding the inside of the heating furnace 10 from external air.

In addition, the lid 11 is provided with a quartz glass window 11W at a region that overlaps the measurement sample container 2 in the axial direction of the heating furnace 10, and the CCD camera 32 is arranged above the window 11W.

In addition, the light source 31 for illuminating the measurement sample S in the heating furnace 10 through the window 11W is arranged on a line above the window 11W, the line being different from the axis of the CCD camera 32.

The light source 31 illuminates the measurement sample S with visible light 40L, and the CCD camera 41 acquires the brightness and intensity of the reflected light 41L from the measurement sample S.

Filters 31F and 32F are arranged between the window 11W and the light source 31 and between the window 11W and the CCD camera 32, respectively so that only a specific component of the visible light is incident on the window 11W and only a specific component of the reflected light enters the CCD camera. However, the filters 31F and 32F are not essential elements. In the case of coaxial episcopic illumination (half-mirror type), the axis of the light source 31 of the illumination light and the optical axis of the camera 32 match.

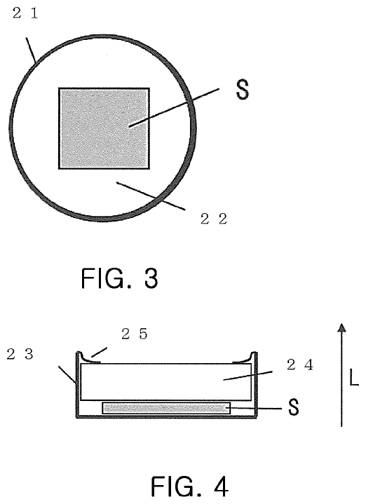

A sample container according to a first embodiment of the present invention will be described by taking the measurement sample container 2 as an example. FIG. 2 is a cross-sectional view of the measurement sample container 2 taken along the axial direction L, and FIG. 3 illustrates the construction of the measurement sample container 2.

The measurement sample container 2 includes a main body 21 which has a cylinder-shaped bottom and an open cylinder-shaped top and a disk-shaped pressure plate 22. The perimeter of the pressure plate 22 is in contact with the inner surface of the opening of the main body 21, is placed on the top surface of the measurement sample S to press the measurement sample S by its own weight, and is in contact with the measurement sample S held on the bottom surface of the main body 21.

In this aspect, since the force of pressing the measurement sample depends on the weight of the pressure plate, it is more effective to make the pressure plate 22 from a highly dense material and increase the thickness of the pressure plate 22.

With this arrangement, since the thermal deformation of the measurement sample is suppressed, the change in the contact surface between the measurement sample and the measurement sample container is suppressed. This provides an effect of stably performing the thermal analysis of the sample, thereby stably measuring the calorific value, the temperature difference, and the weight.

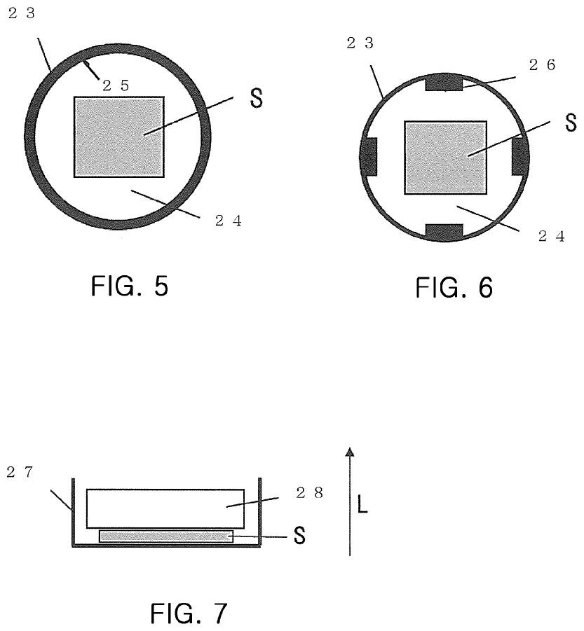

A sample container according to a second embodiment of the present invention will be described by taking the measurement sample container 2 as an example. FIG. 4 is a cross-sectional view of the measurement sample container 2 taken along the axial direction L, and FIG. 5 is a top view illustrating the construction of the measurement sample container 2.

The measurement sample container 2 includes a main body 23 which has a cylinder-shaped bottom and an open cylinder-shaped top and a disk-shaped pressure plate 24. The perimeter of the pressure plate 24 is in contact with the inner surface of the opening of the main body 23, and is placed on the top surface of the measurement sample S held on the bottom surface of the main body. A bent portion 25 that is bent inwards from an upper end of the cylindrical main body 23 presses down the top surface of the pressure plate 24 so that the pressure plate 24 can be fixed.

When the bending area of the bent portion 25 is increased, the pressing force is increased and the thermal deformation of the sample can be more effectively reduced. However, when the area of the bent portion 25 is excessively large, an observation area through which the sample can be observed from above the sample container is reduced. Therefore, it is desirable to appropriately adjust the area of the bent portion depending on the measurement sample.

A sample container according to a modification to the second embodiment of the present invention will be described by taking the measurement sample container 2 as an example. As illustrated in FIG. 6, a portion of a main body 23 may be bent to form a bent portion 26 and a pressure plate 24 is pressed by the bent portion 26. In this case, the force of pressing the measurement sample S is reduced as compared with the second aspect, but it is easier to detach and attach the pressure plate 27 when retrieving or replacing the measurement sample S after the measurement is completed. Therefore, the analysis work can be easily performed.

When a measurement sample is heated, decomposition gas is generated from the measurement sample so that the internal pressure inside the measurement sample container increases. In this case, there is a risk that the sample will explode and scatter around. However, since the decomposition gas can easily escape through a gap between the main body and a portion of the pressure plate which is not pressed by the bent portion, there is an effect that the risk described above is reduced.

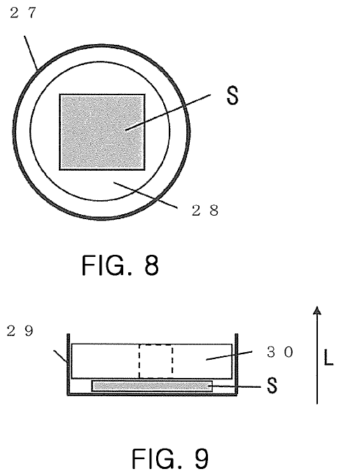

A sample container according to a third embodiment of the present invention will be described by taking the measurement sample container 2 as an example. FIG. 7 is a cross-sectional view of the measurement sample container 2 taken along the axial direction L, and FIG. 8 is a top view illustrating the construction of the measurement sample container 2.

The measurement sample container 2 includes a main body 27 which is a cylinder-shaped bottom and an open cylinder-shaped top and a disk-shaped pressure plate 28 having an outer diameter smaller than an inner diameter of the opening of the main body 27. The pressure plate 28 is placed on the measurement sample S held on the bottom surface of the main body 27 without being in contact with the inner surface of the main body 27. In this embodiment, since the pressure plate 28 is not in contact with the main body 27, there is a gap between the pressure plate 28 and the main body 27.

Decomposition gas generated when the measurement sample S is heated and decomposed can be released to the outside of the measurement sample container 2 through this gap. Therefore, it is possible to reduce a risk that the internal pressure increases due to the decomposition gas and the measurement sample S scatters.

For example, when measuring properties of a polymer material, there is a case where the measurement sample S changes like an adhesive during heating and strongly adheres to the pressure plate 28 of the measurement sample container 2 or the bottom surface of the main body 27 of the measurement sample container 2. In this case, it is possible to easily separate the pressure plate 28 and the main body 27 by inserting tweezers or the like into the gap.

The size and shape of the pressure plate 28 can be freely determined. The smaller the area of the pressure plate compared to the area of the inner diameter of the container, the greater the effect of releasing gas. However, the smaller the area, the smaller the effect of pressing the sample. Therefore, it is desirable to adjust the area of the pressure plate 28 depending on the sample.

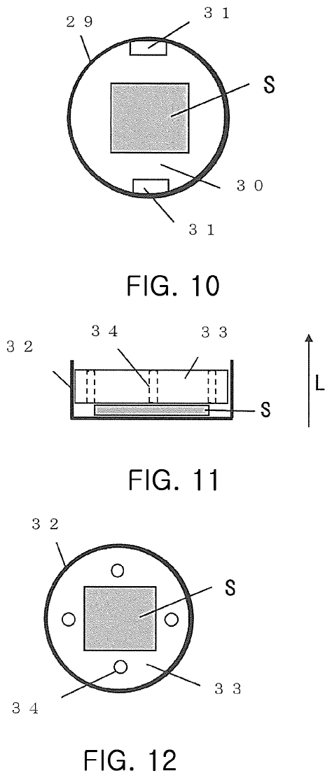

A sample container according to a fourth embodiment of the present invention will be described by taking the measurement sample container 2 as an example. FIG. 9 is a cross-sectional view of the measurement sample container 2 taken along the axial direction L, and FIG. 10 is a top view illustrating the construction of the measurement sample container 2.

The measurement sample container 2 includes a main body 29 which has a cylinder-shaped bottom and an open cylinder-shaped top and a disk-shaped pressure plate 30 with a notch 31. The pressure plate 30 is placed on a measurement sample S held down on the bottom surface of the main body 29.

Since the pressure plate 30 having the notch 31 is used, decomposition gas generated when the measurement sample S is heated and decomposed can be released to the outside of the measurement sample container 2 through the notch. Therefore, it is possible to reduce a risk that the internal pressure increases due to the decomposition gas and the measurement sample S scatters.

In addition, when measuring properties of a polymer material, there is a case where the measurement sample S changes like an adhesive during heating and strongly adheres to the pressure plate 30 and the bottom surface of the main body 29. In this case, it is possible to easily separate the pressure plate 30 and the main body 29 by inserting tweezers or the like into the notch 31.

The number and shape of the notches 31 can be freely determined. The larger the total area of the notches 31, the greater the effect of releasing gas. However, when the total area of the notches is excessively wide, the effect of holding down the sample will be reduced and an observation area for the sample is reduced. Therefore, it is desirable to appropriately adjust the area depending on the sample.

A sample container according to a fifth embodiment of the present invention will be described by taking the measurement sample container 2 as an example. FIG. 11 is a cross-sectional view of the measurement sample container 2 taken along the axial direction L, and FIG. 12 is a top view illustrating the construction of the measurement sample container 2.

The measurement sample container 2 includes a main body 32 which has a cylinder-shaped bottom and an open cylinder-shaped top and a disk-shaped pressure plate 33 with a through hole 34. The pressure plate 33 is placed on a measurement sample S.

Since the pressure plate 33 having the through hole 34 is used, decomposition gas generated when the measurement sample S is heated and decomposed can be released to the outside of the measurement sample container 2 through the through hole. Therefore, it is possible to reduce a risk that the internal pressure increases due to the decomposition gas and the measurement sample S scatters.

The number and shape of the through holes 34 can be freely determined. The larger the total area of the through holes 34, the greater the effect of releasing gas. However, when the total area of the through holes is excessively wide, an observation area for the sample is reduced. Therefore, it is desirable to appropriately adjust the area depending on the sample.

Further embodiments may be implemented by diversely combining the pattern of each embodiment. For example, a pressure plate may be provided with both a notch and a through hole.

Further, for example, a pressure plate may be provided with a through hole and a main body may be provided with a bent portion to press the pressure plate.

On the other hand, it is preferable that a pressure plate which is the same as the pressure plate in the measurement sample container is placed on the reference material R contained in the reference material container 3 so that the measurement sample S and the reference material R can be heated under the same conditions in the heating furnace. On the other hand, the pressure plate placed on the reference material R may be optional.

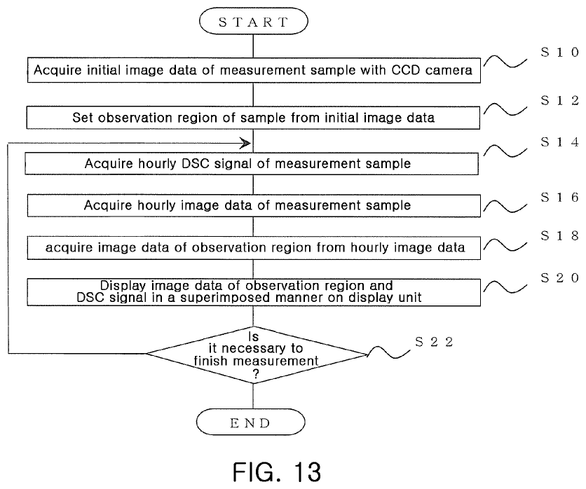

Next, operation of a sample container and a thermal analyzer using the sample container will be described with reference to the flowchart of FIG. 13.

First, a measurement sample S is irradiated with visible light by a light source 31, and initial image data of the measurement sample S is acquired by a CPU 51 of a personal computer 50 using a CCD camera 41 (step S10).

Next, the image data is displayed on a display unit 53 of the personal computer 50, and a user sets position information of a analysis area in an image of the measurement sample S on the display unit 53 using a mouse, a keyboard (not illustrated), or the like. (Step S12).

The position information may be a single point or an area defined with an edge. When one point is specified as the position information, a circular area having a predetermined radius from the point or a predetermined area around the point may be regarded as a virtual area around that point.

A heat flow difference signal (DSC signal) is acquired hourly while the measurement sample S is heated by the heater 12 or cooled by a cooling means (not illustrated) (step S14).

The process in step S14 is similar to the process performed by a conventional differential scanning calorimeter (DSC), in which the measurement sample S itself is heated or cooled, and its differential scanning calorimetric (DSC) value is measured.

In the present invention, the DSC signal is acquired for either time or temperature. In a general differential scanning calorimeter, the heating or cooling rate is constant, and time and temperature correlate with each other.

The CCD 41 acquires an image of the measurement sample S as the image data of the measurement sample S every hour and outputs the image data to the CPU 51 (Step 16).

When the image data is acquired in step S16, it is preferable that the variable is the same as the variable (time in this embodiment) for acquiring the heat flow difference signal (DSC signal) in step S14, but it may be a different variable.

Next, the CPU 51 acquires the image data corresponding to the position information on the measurement sample S, which is set in step S12, from the hourly image data obtained in step S16 (step S18). This image data is stored in the storage unit 52.

When the measurement sample S is a sample having a predetermined area, the value obtained by averaging the brightness or intensity of each pixel of the image data in the area is adopted.

The image data of the measurement sample S acquired in step S18 and the heat flow difference signal (DSC signal) of the measurement sample S acquired in step S14 are displayed on the display unit 53 in a superimposed manner (Step 20). Next, the user determines whether it is necessary to finish the measurement. Next, the measurement is finished when it is necessary (YES) but the process returns to step S14 when it is not necessary (NO) (Step S22).

The determination of whether it is necessary to finish the measurement in step S24 is made such that the time when the maximum or minimum temperature that is predetermined for heating or cooling the measurement sample S is reached is determined as the end point of the measurement. However, the determination of the end point of the measurement is not particularly limited.

In the embodiment described above, visible light is emitted from the light source. However, electromagnetic waves such as X-rays, infrared rays, and ultraviolet rays instead of visible light may be emitted, and the reflected light may be detected by a detector (for example, X-ray detector) instead of the CCD camera.

Further, when the image of the measurement sample S is acquired, a change in color may be acquired. The color may be information obtained by quantifying the brightness of a specific wavelength or information represented by a specific color value. Examples of the quantified information include an LAB (L*A*B) value in the International Commission on Illumination (CIE) 1976 color space, an RGB value that represents a color as a combination of red, green, and blue called three primary colors of light, a CMYK value that represents a color as a combination of cyan, magenta, and yellow called three primary colors and black, etc. However, the quantified information is not limited thereto. For example, an XYZ value in the CIE 1931 color space, an L*u*v value in the CIE 1976 color space, or the CIE CAM02 may be used.

The present invention can be applied not only to a differential scanning calorimeter but also to a differential thermal analyzer (DTA) and a thermogravimetric (TG) analyzer.

1. A sample container used for a thermal analyzer that is used to measure thermal behavior of a sample in accordance with temperature changes from heating or cooling of the sample and to observe the measured sample, the sample container comprising:
a main body having a cylinder-shaped bottom and an open cylinder-shaped top; and
a transparent or translucent pressure plate having a size equal to or less than inner diameter of opening of the main body and pressing the sample placed on a bottom surface of the main body from a top surface of the sample.

2. The sample container according to claim 1, wherein the sample is a polymer film.

3. The sample container according to claim 1, wherein a portion region of the top of a cylinder| of the main body is bent inwards into the opening to form a bent portion that presses the pressure plate from above to fix the pressure plate.

4. The sample container according to claim 1, wherein the pressure plate is provided with a notch or a through hole.

5. A thermal analyzer comprising:
the sample container according to any one of claims 1 to 4;
a heating furnace surrounding the sample container, the heating furnace having an opening; and
an imaging means configured to facilitate observation of the sample through the opening,
wherein the thermal behavior of the sample in the heating furnace is measured according to a change in temperature of the sample.

6. The thermal analyzer according to claim 5, wherein the thermal analyzer is a differential thermal analyzer, a differential scanning calorimeter, or a thermogravimetric analyzer.

7. The thermal analyzer according to claim 5, further comprising: an image processing means configured to generate predetermined color information from image data of the sample acquired by the imaging means,
wherein the color information and the thermal behavior are displayed superimposed on temperature.
